(19) United States
(12) Patent Application Publication
(10) Pub. No.: US 2008/0013503 A1
(43) Pub. Date: Jan. 17, 2008

(54) Bluetooth master with improved transmitting efficiency and method of transmitting data using the same

(75) Inventor: Chan-hyang Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/703,731

(22) Filed: Feb. 8, 2007

(30) Foreign Application Priority Data
Jul. 12, 2006 (KR) 2006-65154

(51) Int. Cl. H04Q 7/24

(52) U.S. Cl. 370/338

(57) ABSTRACT

A Bluetooth master having improved transmission efficiency and a method of transmitting data using the same. The Bluetooth master keeps track of the type of data that its slave devices receive/transmit and adjusts its broadcasting scheme according to the type of data received/transmitted. Therefore, different data types are parsed to different slave devices in a more efficient manner. Thus, it is possible to improve transmission efficiency without changing a communication protocol between the Bluetooth master and the slave device.

### CROSS-REFERENCE TO RELATED APPLICATIONS

This application claims the benefit under 35 U.S.C. § 119 (a) to Korean Patent Application No. 10-2006-0065154, filed on Jul. 12, 2006, the entire disclosure of which is hereby incorporated by reference.

### BACKGROUND OF THE INVENTION

1. Field of the Invention

The present general inventive concept relates to a Bluetooth master having improved transmission efficiency and a method of transmitting data using the same. More particularly, the present general inventive concept relates to a Bluetooth master having improved transmission efficiency by adding information about a slave device to data and transmitting the resulting data only to a target slave device, and a method of transmitting data using the same.

2. Description of the Related Art

Bluetooth is wireless communication technology allowing bi-directional communication without the use of complex wires by wirelessly networking devices in a local area containing computers, mobile telephones, headsets, printers, personal digital assistants (PDAs), notebook computers, and home appliances.

Communication between Bluetooth devices is based on a master-slave connection. A Bluetooth device requesting a connection by setting a frequency hopping order is called a master, and a Bluetooth device accepting the connection by receiving the request from the master and synchronizing itself to the frequency hopping order of the master is called a slave.

FIG. 1 is a diagram illustrating the structure of a typical Bluetooth system.

Referring to FIG. 1, the Bluetooth system contains an access point 10, a master 20, and a plurality of slaves 30-1 to 30-5.

In the Bluetooth system of FIG. 1, the master has a Bluetooth Personal Area Network (PAN) profile and discovers slaves having the Bluetooth PAN profile and thereby connects to the discovered slaves. This connection between one master and at least one slave is called a piconet.

Upon receipt of data from the access point 10, the master 20 broadcasts the data to the plurality of slaves 30-1 to 30-5 connected thereto. The use of such a Bluetooth system allows data to be wirelessly transmitted only using a Bluetooth device without needing an additional device.

However, the Bluetooth protocol stacks v1.2 provides a maximum speed of about 730 kbps, which is slow and not suitable for web surfing or data transmission.

A fundamental problem is that a PAN profile is used to transmit data, the data being basically broadcast according to the features of Transport Control Protocol/Internet Protocol (TCP/IP).

For example, when a connection is established between one master and one slave, only a loss of the transmission speed of the Bluetooth itself is generated since data is transmitted between the master and the slave. However, when a connection is established between one master and n slaves (where, n<=7), the master serves as a kind of an access point. That is, the master sequentially transmits received data to all the slaves connected to one piconet, as in a local area network (LAN). Accordingly, the loss of data throughput is generated by the number of the slaves connected to the master.

Thus, there is a need for a method of minimizing the loss of a transmission speed caused upon broadcasting due to use of a PAN profile in a Bluetooth system.

### SUMMARY OF THE INVENTION

The present general inventive concept provides a Bluetooth master having improved transmission efficiency by adding information about a slave device to data and transmitting resulting data only to a target slave device, and a method of transmitting data using the same.

Additional aspects and advantages of the present general inventive concept will be set forth in part in the description which follows and, in part, will be obvious from the description, or may be learned by practice of the general inventive concept.

The foregoing and other aspects and utilities of the present general inventive concept are substantially realized by providing a Bluetooth master having an interface capable of interfacing communication with at least one or more external devices, a storage part capable of storing a type of data received via the interface, and target slave device information corresponding to the type of data, and a control part capable of transmitting data to a target slave device based on the type of data, wherein the target slave device information corresponds to the type of data when data is received from the at least one or more external devices.

In an exemplary implementation, the Bluetooth master may also contain a discovering part capable of discovering at least one or more slave devices among the at least one or more external devices, and a key value generating part capable of generating a key value corresponding to each slave device discovered by the discovering part.

The control part may insert the key value into the received data and transmit a resulting data to all the discovered slave devices when the target slave device information corresponding to the type of data received does not exist in the storage part.

The control part may store information contained in a slave device response data as the target slave device information corresponding to the type of the transmitted data in the storage part.

In another exemplary implementation, the control part may insert the key value into the received data and transmit a resulting data to all the discovered slave devices when a response data to the transmitted data is not received from the target slave device for a predetermined period of time.

The control part may update the target slave device information stored in the storage part based on a response data when the response data is received from at least one slave device.

The discovering part may discover the slave devices using a service discovery protocol (SDP).

Here, the key value may be generated by mapping a Bluetooth Device (BD) address to each discovered slave device.

The control part may delete the type of data and the target slave device information corresponding to the type of data from the storage part when a target slave device is disconnected.

Here, the target slave device information may be at least one of an Internet Protocol (IP) address, a port number, and a key value of a target slave device.

The foregoing and/or other aspects and utilities of the present general inventive concept are also achieved by providing a method of transmitting data using a Bluetooth master, the method including receiving data from an external device and transmitting the received data to a corresponding target slave device based on target slave device information previously stored according to a type of data of the received data.

In an exemplary implementation, the method may further include discovering slave devices among external devices; and generating a key value corresponding to each discovered slave device.

The method may further include inserting the key value into the received data and transmitting a resulting data to all the discovered slave devices when the target slave device information corresponding to the type of received data does not exist.

In an exemplary implementation, the method may further include storing information contained in a response data received from at least one slave device as the target slave device information corresponding to the type of the transmitted data.

The method may further include inserting the key value into the received data and transmitting a resulting data to all the discovered slave devices when a response data to the transmitted data is not received from the target slave device for a predetermined period of time.

The method may further include updating the target slave device information based on a response data when the response data is received from at least one slave device.

The discovering operation may discover the slave devices using a service discovery protocol (SDP).

Here, the key value may be generated by mapping a BD address to each discovered slave device.

The method may further include deleting target slave device information from previously stored information, when any slave device among the external devices is disconnected.

Here, the target slave device information may be at least one of an Internet Protocol (IP) address, a port number, and a key value of the slave device.

The foregoing and/or other aspects and utilities of the present general inventive concept may also be achieved by providing a computer readable recording medium having embodied thereon a computer program to execute a method of transmitting data using a Bluetooth master, the method including receiving data from an external device, and transmitting the received data to a corresponding target slave device based on target slave device information previously stored according to a type of data of the received data.

The embodied method in the computer recording medium may further include discovering slave devices among external devices, and generating a key value corresponding to each discovered slave device. A key value may be inserted into the received data and a resulting data may be transmitted to all the discovered slave devices when the target slave device information corresponding to the type of received data does not exist.

The foregoing and/or other aspects and utilities of the present general inventive concept may also be achieved by providing a Bluetooth master including an interface module capable of communicating with at least one external device, wherein the at least one external device is a slave device, a storage module capable of storing information on a type of data receivable by the slave device, and a control module capable of coordinating a transfer of data to a slave device based on a type of data received via the interface module, wherein the data transmitted to the slave device corresponds to the type of data receivable by the slave device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram illustrating the structure of a typical Bluetooth system;

FIG. 2 is a block diagram illustrating the structure of a Bluetooth master according to an exemplary embodiment of the present general inventive concept;

FIG. 3 is a block diagram illustrating the structure of a Bluetooth master according to another exemplary embodiment of the present general inventive concept;

FIGS. 4 to 6 are diagrams illustrating a data transmission process in a Bluetooth system having a Bluetooth master according to an exemplary embodiment of the present general inventive concept;

FIG. 7 is a schematic diagram illustrating data transmission according to an exemplary embodiment of the present general inventive concept;

FIG. 8 is a schematic diagram illustrating a format of an L2CAP data packet according to an exemplary embodiment of the present general inventive concept;

FIG. 9 is a flowchart illustrating a method of transmitting data using a Bluetooth master according to an exemplary embodiment of the present general inventive concept;

FIG. 10 is a flowchart illustrating a method of storing slave device information according to an exemplary embodiment of the present general inventive concept; and

FIG. 11 is a flowchart illustrating a method of transmitting data using a Bluetooth master according to another exemplary embodiment of the present general inventive concept.

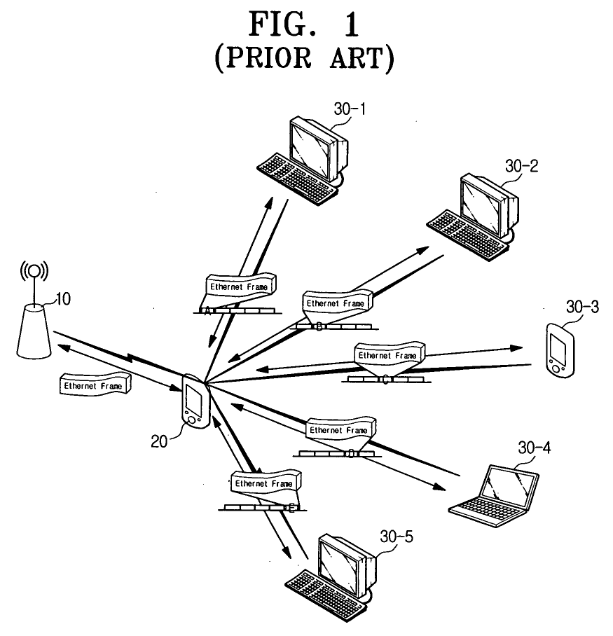

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, exemplary embodiments of the present general inventive concept will be described in detail with reference to the accompanying drawings.

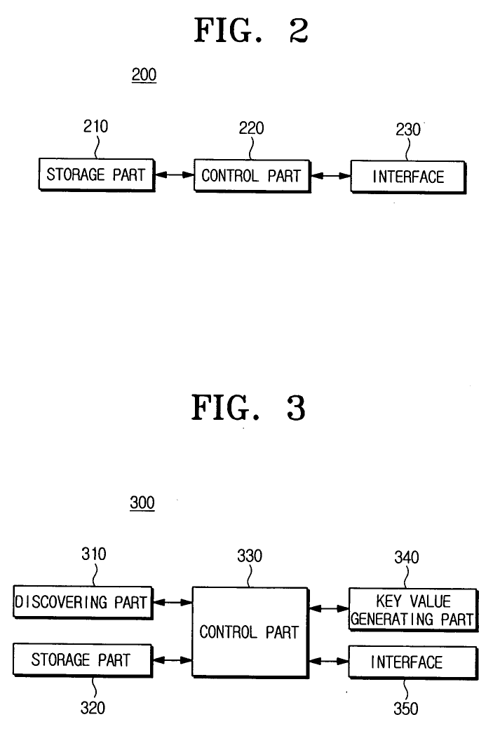

FIG. 2 is a block diagram illustrating the structure of a Bluetooth master according to an exemplary embodiment of the present general inventive concept.

Referring to FIG. 2, a Bluetooth master 200 may include a storage part 210, a control part 220, and an interface 230.

The Bluetooth master 200 is connected to the Internet (not illustrated) in a wired or wireless manner, and may control all communications in a piconet. Further, the Bluetooth master 200 has a personal area network (PAN) profile and may be connected to slave devices (not illustrated) having a PAN profile. The Bluetooth master 200 can transmit received data from an access point (not illustrated) to the slave devices. It should be appreciated that while FIG. 2 does not illustrate the access point, Internet, external devices, and/or slave devices, it is understood that they may be present, as needed, and information and/or data may be communicated accordingly.

According to the PAN profile, Logical Link Control and Adaptation Protocol (L2CAP) data is generated using a Bluetooth network encapsulation protocol (BNEP), and then a piconet IP PAN is built so that the Bluetooth master 200 has both a master forwarding function and an access point function.

The storage part 210 may store the type of data received via the interface 230, and also target slave device information corresponding to the received data type.

Here, the target slave device information may be at least one of an IP address, a port number, and a key value of the slave device.

When the control part 220 receives data from the access point among the external devices, it may parse the received data to recognize the type of data received. When the type of data received is recognized, the control part 220 may transmit the received data only to a target slave device corresponding to the data type of the received data using the target slave device information stored in the storage part 210.

The interface 230 can interface communications with the external devices. Here, the external device may be any one of the access point and at least one of the slave devices.

Further, the interface 230 may receive data from the access point among the external devices, and also receive slave device information from at least one slave device connected to the Bluetooth master 200.

The interface 230 may transmit the received data to the target slave device under control of the control part 220.

FIG. 3 is a block diagram illustrating the structure of a Bluetooth master 300 according to another exemplary embodiment of the present general inventive concept.

Referring to FIG. 3, the Bluetooth master 300 may include a discovering part 310, a storage part 320, a control part 330, a key value generating part 340, and an interface 350.

The discovering part 310 can discover slave devices having a PAN profile among the external devices. Here, the discovering part 310 may use a service discovery protocol (SDP) to discover the slave devices.

The storage part 320 can store information about the discovered slave devices, and a key value corresponding to each slave device information.

Under control of the control part 330, the storage part 320 may store the slave device information as target slave device information corresponding to the data type of data received.

In storing the detected slave device information, when target slave device information corresponding to the type of the data exists, the storage part 320 may update the existing information with the detected slave device information.

The control part 330 may have the same function as the control part 220 of FIG. 2.

The control part 330 may determine whether target slave device information corresponding to the received data exists in the storage part 320. If it is determined that the target slave device information does not exist, the control part 330 inserts a key value generated by the key value generating part 340 into the data to generate L2CAP data.

The control part 330 can then transmit the generated L2CAP data to all slave devices discovered by the discovering part 310. The slave devices, upon receiving the L2CAP data, transmit response data to the Bluetooth master 300.

The response data may be received from at least one or all of the slave devices via the interface 350, and the control part 330 may detect slave device information from the received response data.

The control part 330 may control the storage part 320 to store the detected slave device information as the target slave device information corresponding to the data.

Upon receipt of a request to disconnect the slave device from the master 300, the control part 330 may disconnect the slave device. In this case, the control part 330 may delete the type of data and the target device information corresponding to the type of data from the storage part 320.

When response data is not received from any slave device for a predetermined period of time, the control part 330 may insert a key value generated by the key value generating part 340 into the received data via the interface 350 to generate L2CAP data.

The control part 330 may then re-transmit the generated L2CAP data to all slave devices discovered by the discovering part 310.

The control part 330 may also detect slave device information from response data received from a target slave device.

In storing the detected slave device information in the storage part 320, when there is target slave device information corresponding to the data type of the transmitted data, the control part 330 may control the storage part 320 so that the detected slave device information is updated with the target slave device information corresponding to the type of the transmitted data.

Accordingly, the control part 330 may insert a key value into data to be transmitted to all the slave devices and transmit the resulting data to the slave devices, and may receive response data from any slave device. The control part 330 may control the storage part 320 to store the slave device information, for example, an IP address, a port number, and a key value of the slave device detected from the received response data as the target slave device information corresponding to the data type of the transmitted data.

Thereafter, when the same data is received via the interface 350, the control part 330 may transmit the received data only to a target slave based on the target slave device information corresponding to the data type stored in the storage part 320.

The key value generating part 340 may number all the discovered slave devices, and map a Bluetooth device (BD) address of each slave device to generate a key value. Here, the BD address may be, for example, a 48-bit MAC address of a network adapter for the slave device.

The interface 350 may have the same function as the interface 230 of FIG. 2 and receive, from the slave device, response data to the data transmitted to all the slave devices.

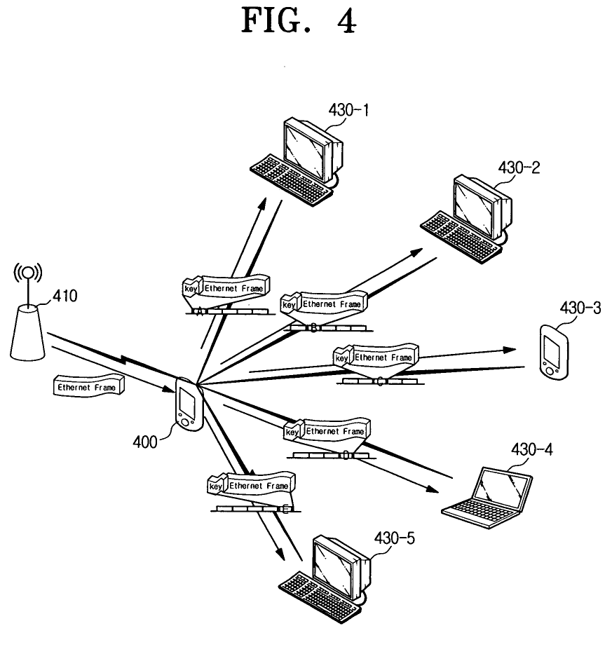

FIGS. 4 to 6 are diagrams illustrating a data transmission process in a Bluetooth system having a Bluetooth master 400 according to an exemplary embodiment of the present general inventive concept.

Referring to FIG. 4, a Bluetooth master 400 transmits data received from an access point 410 to all slave devices 430-1 to 430-5 connected to the Bluetooth master 400 using a PAN profile.

In this case, the Bluetooth master 400 parses a portion of the data received from the access point 410 to check the data type of the received data. The Bluetooth master 400 inserts a key value that is generated based on a BD address of all the slave devices 430-1 to 430-5 connected thereto using a PAN profile, into the data and transmits the resulting data to all the slave devices 430-1 to 430-5.

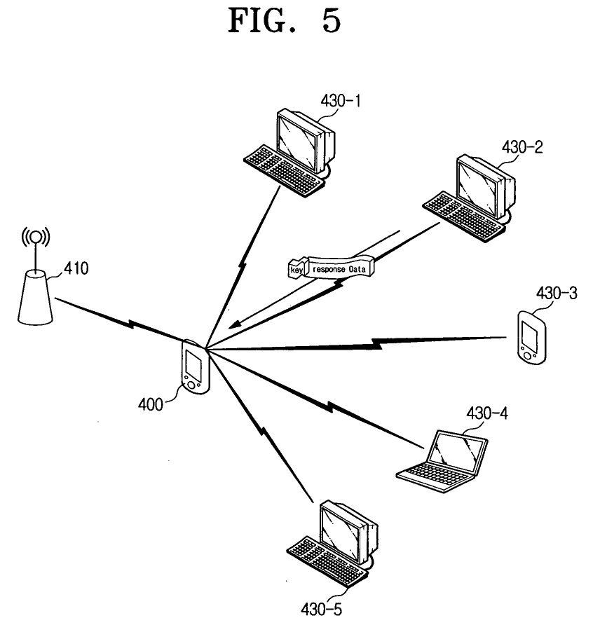

Referring to FIG. 5, a Bluetooth master 400 receives response data from one slave device 430-2 among the slave devices 430-1 through 430-4 receiving the data having the inserted key value. In this case, the Bluetooth master 400 detects information about the slave device 430-2 from the response data and stores the detected information about the slave device 430-2 as target slave device information corresponding to the data received from the access point 410. Here, the information about the slave device 430-2 may be, for example, an IP address, a port number, and a key value of the slave device 430-2.

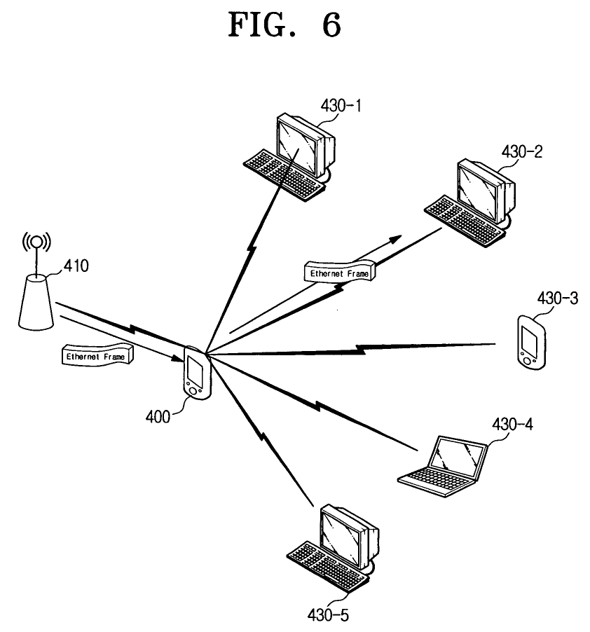

Referring to FIG. 6, when receiving the same data from the access point 410, the Bluetooth master 400 parses the received data to recognize the type of received data. When having target slave device information corresponding to the data type of the received data, the Bluetooth master 400 inserts the target slave device information into the received data to generate L2CAP data.

The Bluetooth master 400 transmits the generated L2CAP data only to the target slave device 430-2.

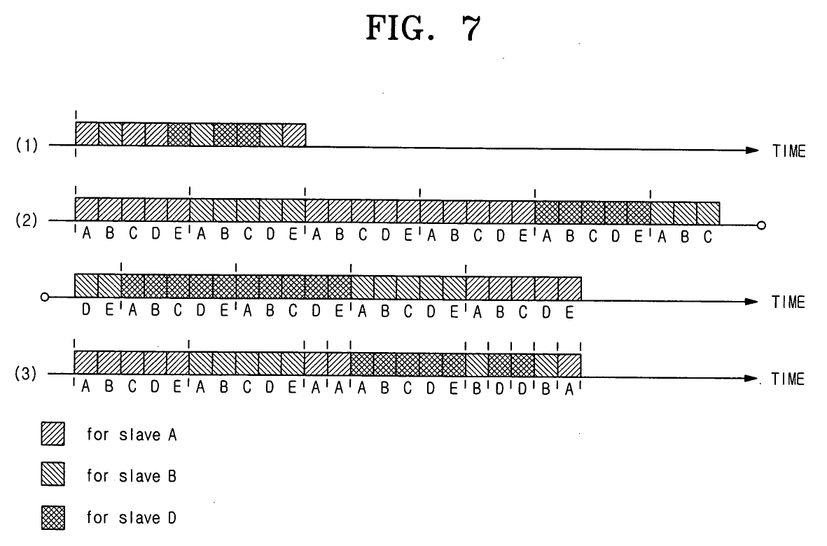

FIG. 7 is a schematic diagram illustrating a data transmission scheme according to an exemplary embodiment of the present general inventive concept.

Referring to FIG. 7, (1) indicates a transmission format of data A, B, and D which are subsequently transmitted from an external device to a Bluetooth master. Here, data A should be transmitted to the slave device A, data B to the slave device B, and data D to the slave device D.

(2) indicates a conventional transmission format in which slave devices A to D are connected to a Bluetooth master. According to the data flow indicated by (1), the Bluetooth master transmits data A to slave devices A to D and transmits data B to the slave devices A to D. And even when transmitting data A once more, the Bluetooth master transmits data A to the slave devices A to D. In this manner, the data is transmitted from the Bluetooth master to each slave device A.

(3) indicates a transmission format according to exemplary embodiments of the present invention. According to the data flow indicated by (1), the Bluetooth master transmits initial data, data A, to slave devices A to D and transmits data B to the slave devices A to D. When receiving and transmitting data A once more, the Bluetooth master transmits data A only to the slave device.

Accordingly, the Bluetooth master inserts the key value into data received from the external device and transmits resulting data to the slave device. When receiving response data from the slave device, the Bluetooth master stores the target slave device information corresponding to the data based on slave device information detected from the response data. This allows the Bluetooth master to recognize the target slave device when receiving data again.

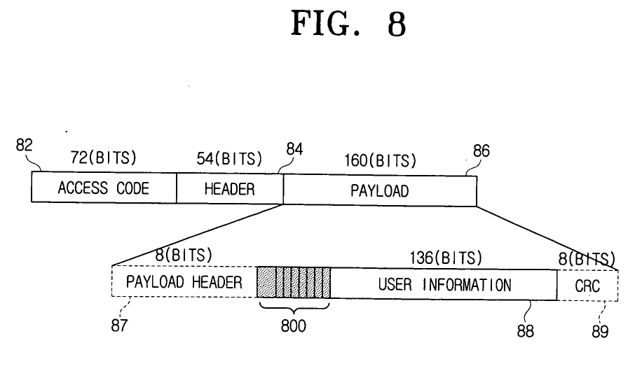

FIG. 8 is a schematic diagram illustrating the format of an L2CAP data packet 80 according to an exemplary embodiment of the present general inventive concept.

Referring to FIG. 8, a L2CAP data packet 80 contains a 72-bit access code 82, a 54-bit header 84, and a 160-bit payload 86. In this case, the access code contains a sync word (not illustrated) capable of synchronizing one packet for an entire data block.

The 160-bit payload 86 contains a 8-bit payload header 87, 136-bit user information 88, and 16-bit CRC 89. According to exemplary embodiments of the present general inventive concept, a BD address of each slave device and a key value generated based on the BD address are inserted into a first portion 90 of the user information. The length of the key value may be set in the header portion 87 of the payload 86.

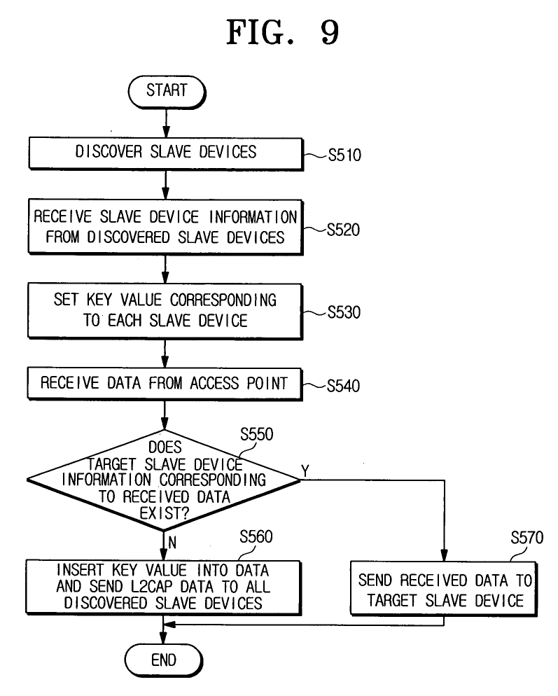

FIG. 9 is a flowchart illustrating a method of transmitting data using a Bluetooth master according to an exemplary embodiment of the present general inventive concept.

Referring to FIG. 9, a Bluetooth master having a PAN profile on the Internet discovers slave devices having a PAN profile using a service discovery protocol (SDP) (operation S510).

When the discovery is completed, the Bluetooth master receives slave device information from all the discovered slave devices (operation S520). Here, the slave device information may be a BD address, for example, a 48-bit MAC address, of the slave device.

Specifically, the discovered slave devices are listed and in this case, slave devices in an active state are connected to the Bluetooth master. For the slave devices, the Bluetooth master is a data exchange part, which serves as an access point.

The Bluetooth master then numbers all the slave devices and maps a BD address received from the slave device to generate a key value (operation S530).

When the Bluetooth master receives data from the access point among external devices (operation S540), it parses the received data to recognize the data type of the received data.

In this case, the Bluetooth master determines whether target slave device information corresponding to the recognized data type exists (operation S550). Here, the target slave device information may be an IP address and a port number of the slave device.

If it is determined that the target slave device does not exist (operation S550: N), the Bluetooth master inserts a key value into the received data to generate L2CAP data and transmits the generated L2CAP data to all the slave devices (operation S560). In this case, broadcasting is used to exactly locate the slave devices.

If it is determined that the target slave device exists (operation S550: Y), the Bluetooth master inserts the target slave device information stored therein into the received data to generate L2CAP data and transmits the generated L2CAP data only to the target slave device (operation S570).

Here, the presence of the target slave device indicates that the Bluetooth master has transmitted the same data as the received data once or more, i.e., that the Bluetooth master has received response data from a slave device corresponding to the transmitted data and has stored slave device information, for example, an IP address, a port number, and a key value of the slave device.

Inserting the target slave device information into the data even though the key value is inserted into the data is intended to cope with the sudden possibility of data loss and to prevent transmission failure caused by a key value being lost between Bluetooth devices due to communication errors.

In the exemplary embodiment of FIG. 9, operations S510, S520, and S530 have been described as being performed before the Bluetooth master receives data from the access point (operation S540). In another exemplary embodiment, however, the operations may be performed after the Bluetooth master receives data from the access point (operation S540), and therefore the present general inventive concept is not limited thereto.

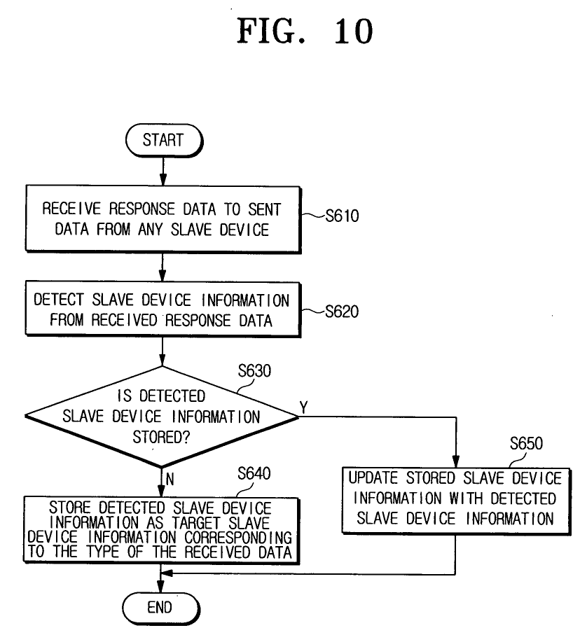

FIG. 10 is a flowchart illustrating a method of storing slave device information according to an exemplary embodiment of the present general inventive concept.

Referring to FIG. 10, a Bluetooth master receives, from any slave device, response data to data that the Bluetooth master has transmitted to the slave device (operation S610).

Here, upon receipt of the data, the slave device separately stores a received key value and transmits the response data to the Bluetooth master to indicate correct reception of the data.

The Bluetooth master detects slave device information from the received response data (operation S620) and determines whether the detected slave device information is stored (operation S630). Here, the response data may be an IP address, a port number, and a key value, for example.

If it is determined that the slave device information is not stored (operation S630: Y), the Bluetooth master stores the detected slave device information as target slave device information corresponding to the transmitted data (operation S640).

If it is determined that the slave device information is stored (operation S630: Y), the Bluetooth master updates the stored target slave device information corresponding to the transmitted data with the detected slave device information (operation S650).

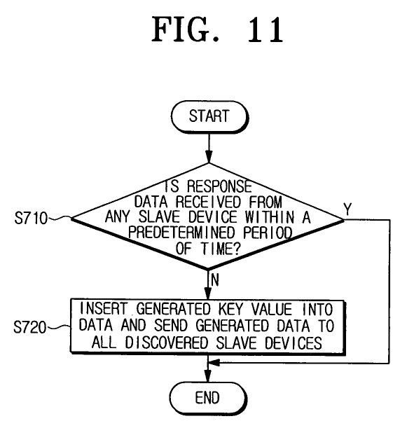

FIG. 11 is a flowchart illustrating a method of transmitting data using a Bluetooth master according to another exemplary embodiment of the present general inventive concept.

Referring to FIG. 11, the Bluetooth master determines whether it has received response data to data transmitted to all slave devices from any slave device of the slave devices within a predetermined period of time (operation S710). When the response data is not received from the slave device for a given period of time (operation S710: N), the Bluetooth master inserts a key value generated corresponding to a BD address of the slave device into the data to generate L2CAP data. The Bluetooth master transmits the generated data to all the slave devices (operation S720). In this case, broadcasting may be used to exactly locate a slave device.

Meanwhile, the Bluetooth master can disconnect the slave device from the Bluetooth master. When the slave device is disconnected, the information about the slave device stored in the Bluetooth master is deleted.

As described above, according to exemplary embodiments of the present general inventive concept, it is possible to improve transmission efficiency without changing a communication protocol between the Bluetooth master and the slave device by adding information about the slave device to data and transmitting resulting data only to a target slave device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A Bluetooth master comprising:
an interface capable of interfacing communication with one or more external devices;
a storage part capable of storing a type of data received via the interface, and target slave device information corresponding to the type of data; and
a control part capable of transmitting data to a target slave device based on the type of data, wherein the target slave device information corresponds to the type of data when data is received from the one or more external devices.

2. The Bluetooth master according to claim 1, further comprising:
a discovering part capable of discovering at least one or more slave devices among the one or more external devices; and
a key value generating part capable of generating a key value corresponding to each slave device discovered by the discovering part.

3. The Bluetooth master according to claim 2, wherein the control part inserts the key value into the received data and transmits a resulting data to all the discovered slave devices when the target slave device information corresponding to the type of data received does not exist in the storage part.

4. The Bluetooth master according to claim 3, wherein the control part stores information contained in a slave device response data as the target slave device information corresponding to the type of the transmitted data in the storage part.

5. The Bluetooth master according to claim 2, wherein the control part inserts the key value into the received data and transmits a resulting data to all the discovered slave devices when a response data to the transmitted data is not received from the target slave device for a predetermined period of time.

6. The Bluetooth master according to claim 3, wherein the control part updates the target slave device information stored in the storage part based on a response data when the response data is received from at least one slave device.

7. The Bluetooth master according to claim 2, wherein the discovering part discovers the slave devices using a service discovery protocol (SDP).

8. The Bluetooth master according to claim 2, wherein the key value is generated by mapping a Bluetooth Device (BD) address to each discovered slave device.

9. The Bluetooth master according to claim 1, wherein the control part deletes the type of data and the target slave device information corresponding to the type of data from the storage part when a target slave device is disconnected.

10. The Bluetooth master according to claim 1, wherein the target slave device information is at least one of an Internet Protocol (IP) address, a port number, and a key value of a target slave device.

11. A method of transmitting data using a Bluetooth master, the method comprising:
receiving data from an external device; and
transmitting the received data to at least one corresponding target slave device based on target slave device information previously stored according to a type of data of the received data.

12. The method according to claim 11, further comprising:
discovering slave devices among external devices; and
generating a key value corresponding to each discovered slave device.

13. The method according to claim 12, further comprising:
inserting the key value into the received data and transmitting a resulting data to all the discovered slave devices when the target slave device information corresponding to the type of received data does not exist.

14. The method according to claim 13, further comprising:
storing information contained in a response data received from at least one slave device as the target slave device information corresponding to the type of the transmitted data.

15. The method according to claim 12, further comprising:
inserting the key value into the received data and transmitting a resulting data to all the discovered slave devices when a response data to the transmitted data is not received from the target slave device for a predetermined period of time.

16. The method according to claim 13, further comprising:
updating the target slave device information based on a response data when the response data is received from at least one slave device.

17. The method according to claim 12, wherein the discovering operation comprises discovering the slave devices using a service discovery protocol (SDP).

18. The method according to claim 12, wherein the key value is generated by mapping a Bluetooth Device (BD) address to each discovered slave device.

19. The method as claimed in claim 11, further comprising, deleting target slave device information from previously stored information, when any slave device among the external devices is disconnected.

20. The method according to claim 11, wherein the target slave device information is at least one of an Internet Protocol (IP) address, a port number, and a key value of the slave device.

21. A computer readable recording medium having embodied thereon a computer program to execute a method of transmitting data using a Bluetooth master, the method comprising:
receiving data from an external device; and
transmitting the received data to at least one corresponding target slave device based on target slave device information previously stored according to a type of data of the received data.

22. The computer readable recording medium according to claim 21, further comprising:
discovering slave devices among external devices; and
generating a key value corresponding to each discovered slave device.

23. The computer readable recording medium according to claim 22, further comprising:
inserting the key value into the received data and transmitting a resulting data to all the discovered slave devices when the target slave device information corresponding to the type of received data does not exist.

24. A Bluetooth master comprising:
an interface module capable of communicating with at least one external device, wherein the at least one external device is a slave device;
a storage module capable of storing information on a type of data receivable by the slave device; and
a control module capable of coordinating a transfer of data to a slave device based on a type of data received via the interface module, wherein the data transmitted to the slave device corresponds to the type of data receivable by the slave device.

25. The Bluetooth master according to claim 24, further comprising:
a discovery module capable of discovering a slave device among at least one external device; and
a key value generator capable of generating a key value corresponding to each discovered slave device, wherein
the control module modifies the received data with the key value and transmits the modified received data to all discovered slave devices when the information on the type of data receivable by a slave device does not correspond to the type of data received via the interface module.

26. The Bluetooth master according to claim 24, wherein the control module updates the information stored in the storage module based on response data received from at least one or more slave devices.
